(19) United States
(12) Patent Application Publication
(10) Pub. No.: US 2025/0330218 A1
(43) Pub. Date: Oct. 23, 2025

(54) UPLINK CODEBOOK DESIGN AND RELATED SIGNALING

(71) Applicant: Apple Inc., Cupertino, CA (US)

(72) Inventors: Weidong Yang, San Diego, CA (US); Wei Zeng, Saratoga, CA (US); Dawei Zhang, Saratoga, CA (US); Sigen Ye, San Diego, CA (US); Haitong Sun, Saratoga, CA (US); Huaning Niu, San Jose, CA (US); Hong He, San Jose, CA (US); Yushu Zhang, Beijing (CN); Seyed Ali Akbar Fakoorian, San Diego, CA (US)

(73) Assignee: Apple Inc., Cupertino, CA (US)

(21) Appl. No.: 18/860,623

(22) PCT Filed: Apr. 28, 2022
(86) PCT No.: PCT/CN2022/089918

§ 371 Date: Oct. 25, 2024

(51) Int. Cl. H04B 7/06; H04L 5/00

(52) U.S. Cl. CPC H04B 7/0617; H04L 5/0051

(57) ABSTRACT

Provided is a method performed by a user equipment (UE). The method comprises: receiving, from a base station (BS), one or more messages comprising precoding information, wherein the precoding information is used by the UE to determine a precoder used in a codebook-based Physical Uplink Shared Channel (PUSCH) transmission; performing, by the UE, the codebook-based PUSCH transmission using eight antenna ports based on the precoder.

### TECHNICAL FIELD

This application relates generally to wireless communication systems, and more specifically to uplink codebook design and related signaling.

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as a Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### SUMMARY

According to an aspect of the present disclosure, a method performed by a user equipment (UE) is provided. The method comprises: receiving, from a base station (BS), one or more messages comprising precoding information, wherein the precoding information is used by the UE to determine a precoder used in a codebook-based Physical Uplink Shared Channel (PUSCH) transmission; performing, by the UE, the codebook-based PUSCH transmission using eight antenna ports based on the precoder.

According to an aspect of the present disclosure, a method performed by a communication network is provided. The method comprises: transmitting, to a user equipment (UE), one or more messages comprising precoding information, wherein the precoding information is used by the UE to determine a precoder used in a codebook-based Physical Uplink Shared Channel (PUSCH) transmission; receiving, from the UE, the codebook-based PUSCH transmission using eight antenna ports based on the precoder.

According to an aspect of the present disclosure, an apparatus for a user equipment (UE) is provided. The apparatus comprises one or more processors configured to perform steps of the method according to any of methods by the UE provided herein.

According to an aspect of the present disclosure, an apparatus for a communication network is provided. The apparatus comprises one or more processors configured to perform steps of the method according to any of methods by the BS provided herein.

According to an aspect of the present disclosure, a computer readable medium is provided, having computer programs stored thereon which, when executed by one or more processors, cause an apparatus to perform steps of the method according to any of methods provided herein.

According to an aspect of the present disclosure, an apparatus for a communication device is provided. The apparatus comprises means for performing steps of the method according to any of methods provided herein.

According to an aspect of the present disclosure, a computer program product is provided, comprising computer programs which, when executed by one or more processors, cause an apparatus to perform steps of the method according to any of methods provided herein.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station (BS) and a user equipment (UE) in accordance with some embodiments.

FIG. 2 illustrates a flowchart for a method performed by a UE in accordance with some embodiments.

FIG. 3 illustrates a transmit scenario with precoding information between a UE and a communication network in accordance with some embodiments.

FIG. 4 illustrates a codebook design in accordance with some embodiments.

FIG. 5A illustrates another codebook design in accordance with some embodiments.

FIG. 5B illustrates another codebook design in accordance with some embodiments.

FIG. 6A illustrates another codebook design in accordance with some embodiments.

FIG. 6B illustrates another codebook design in accordance with some embodiments.

FIG. 7 illustrates another codebook design in accordance with some embodiments.

FIG. 8 illustrates an antenna configuration scenario in accordance with some embodiments.

FIG. 9 illustrates a signaling design in accordance with some embodiments.

FIG. 10 illustrates another signaling design in accordance with some embodiments.

FIG. 11 illustrates another signaling design in accordance with some embodiments

FIG. 12 illustrates a flowchart for a method performed by a BS in accordance with some embodiments.

FIG. 13 illustrates a block diagram of an apparatus for a UE in accordance with some embodiments.

FIG. 14 illustrates a block diagram of an apparatus for a communication network in accordance with some embodiments.

FIG. 15 illustrates example components of a device in accordance with some embodiments.

FIG. 16 illustrates example interfaces of baseband circuitry in accordance with some embodiments.

FIG. 17 is a block diagram illustrating components, according to some example embodiments.

FIG. 18 illustrates an architecture of a system of a network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

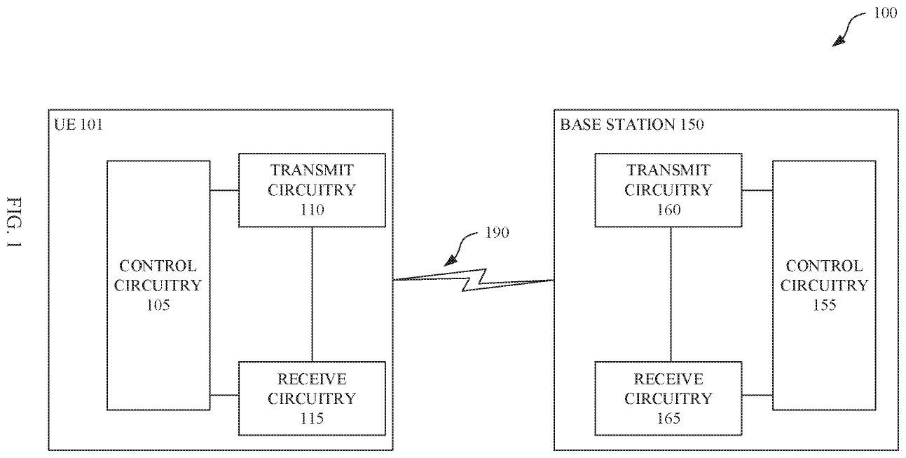

FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120 degree area with an array of antennas directed to each sector to provide 360 degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuity 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g. messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person to person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is comprised of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

As codebooks for NR need to support diverse radio environments and various UE practical issues. In Rel-18 feMIMO, the eight-transmitter (8Tx) codebook for uplink (UL) transmission will be specified to enable 8Tx UL operation to support 4 and more layers per UE in UL targeting Customer Premises Equipment (CPE), Fixed Wireless Access FWA, vehicle, and/or Industrial devices.

Difference UEs may have various antenna configurations. For CPE/FWA, regular antenna configurations as seen at base stations are possible. For vehicle, the antenna can be mounted on roof, bumper, glass, rear mirror, etc. For industrial device, it may be covered by those antenna configurations for CPE/FWA and vehicle.

In the related UL codebook design, UL codebooks have been specified for LTE Rel-10, 2Tx, 4Tx (e.g., TS 36.213), and NR Rel-15, 2Tx, 4Tx (e.g., TS 38.211 or TS 38.214 for DL). In some designs, coherence levels like non-coherence, partial coherence and full coherence are also considered. The coherence here is mainly about phase discontinuity, phase noise, etc., and it is covered by RAN4 specification. In some designs, codebook design for full power transmission is also considered (e.g., NR Rel-16).

In some 8Tx codebook designs for CPE in accordance with some embodiments, it may be expected similar design as for base station can be used. For example, Type I can be considered. Also, in order to handle coherent/non-coherent/partially coherent antenna configurations, additional codewords for non-coherent/partially coherent antenna configurations can be added besides those for coherent antenna configurations in a single codebook, or they can be included in separate codebooks, e.g. one for coherent antenna configurations and another for non-coherent antenna configurations, yet another for partially coherent antenna configurations. Alternatively more than one codebook can be supported, with one codebook supports some antenna configurations, and another codebook supports some antenna configurations, and the supported antenna configurations in two codebooks may not be the same.

In some 8Tx codebook designs for vehicle UEs in accordance with some embodiments, antennas can be installed on roof, bumper, glass etc. In some examples, effectively multiple panels, e.g., 2 or 4 or 8, can be considered and the 8Tx consists of transmissions from multiple panels. For example, with 2 panels, cophasing can be introduced, and codebook design within each panel can reuse a Rel-15 4Tx codebook, and normalization and single antenna selection can be supported.

In some 8Tx codebook designs for industrial devices in accordance with some embodiments, they may either similar to CPE or vehicle UE.

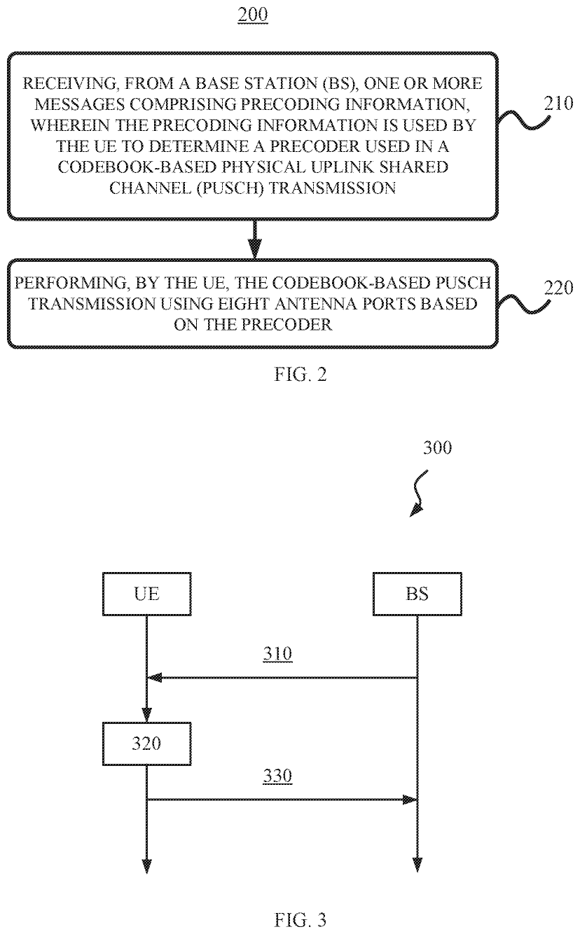

FIG. 2 illustrates a flowchart for a method 200 performed by a UE in accordance with some embodiments. As shown in FIG. 2, method 200 comprises step 210 and step 220.

In step 210, UE receives, from a base station (BS), one or more messages comprising precoding information. The precoding information is used by the UE to determine a precoder used in a codebook-based Physical Uplink Shared Channel (PUSCH) transmission.

In step 220, UE performs the codebook-based PUSCH transmission using eight antenna ports based on the precoder.

In some implementations, the precoder may be designed as wideband precoder. It has the benefit that the signaling overhead can be smaller, and less issue with implementation. For example, there is no need to deal with additional Peak-to-Average Power Ratio (PAPR) issue from subband precoding.

In some implementations, the precoder may be designed as subband precoder. In some examples, it may use some designs similar to DL's Type I codebook.

In some implementations, the precoder may be designed as a single stage (flattened) or 2-stage codebook as in Type I/Type II MIMO codebook in DL. With a single stage codebook, the codebook construction structure may not be kept in the list of precoding codewords.

FIG. 3 illustrates a transmit scenario 300 with precoding information between a UE and a communication network in accordance with some embodiments. As shown in FIG. 3, BS transmits one or more messages comprising precoding information 310 to UE. UE then determine the precoder 320 based on the precoding information 310. Using the precoder 320, UE process data to be transmitted to BS. In 330, UE perform a codebook-based PUSCH transmission with eight antenna ports to transmit the processed data to the BS.

In some embodiments, the precoding information may comprise sounding reference signal resource indicator (SRI), Transmit Precoder Matrix Indicator (TPMI), number of layers, and other information used for 8Tx uplink transmission.

In some embodiments, the UE may report its capability to BS. For example, the UE may report whether it supports full-coherent, partially-coherent transmission and level of partial coherence, or non-coherent transmission. The level of partial coherence includes the support of coherent transmission within a group of antenna ports and the number of groups. A group of antenna ports may correspond to a UE panel. With a notation as CC (x,y) to denote the U coherence capability, where x is the number of coherent antenna ports per group, and y the number of groups, the signaling of CC (2,4) and/or CC (4,2) can be reported by the UE. CC (4,2) can be considered as a stronger capability than C (2,4). If there are precoding codewords designed for CC (2,4), then network may signal the UE to use one of them if the UE reports in its capability signaling that the UE support CC (4,2). It is noted non-coherent transmission capability can be denoted as CC (1,8), and full coherent transmission capability can be denoted as CC (8,1). If a UE reports a certain capability, Precoding codewords for a less capability can be used, following the order of CC (8,1)>CC (4,2)>CC (2,4)>CC (1,8).

In some implementations, the precoder may be designed to support different coherence level (non-coherence, partial coherence, full coherence). For example, a single codebook and depending on UE capability and network configuration, a sub-codebook can be derived as in Rel-15. In some variants, the single stage (flattened) design makes it easier to support codewords for non-coherent/partially coherent transmission. When considering vehicle UE and CPE, they may be able to support coherent transmission more readily, the two stage codebook may be used, with all codewords for coherent transmission.

In some embodiments, the precoder may be constructed by concatenation from two codewords. For example, the precoder may be determined from a first sub-precoder and a second sub-precoder, the first sub-precoder is determined from a first codebook and the second sub-precoder is determined from a second codebook.

In some embodiments, the eight antenna ports of UE may comprise two antenna panels, the first sub-precoder is associated with a first antenna panel and the second sub-precoder is associated with a second antenna panel, both the first codebook and the second codebook are four-transmitter codebook, and the precoder is a concatenation determined from the first sub-precoder, the second sub-precoder and a cophase between the first antenna panel and the second antenna panel. For example, the 8Tx precoder W can be constructed as:

$$[ \begin{matrix}{v}_{1} \\ α {v}_{2}\end{matrix} ]$$

where ν₁ is the first sub-precoder with 4 rows and l column, ν₂ is the second sub-precoder with 4 rows and l column, where l is the number of layer; α is the cophase between the first antenna panel and the second antenna panel. In some examples, ν₁ and ν₂ are for each polarization or panel.

In some embodiments, the first codebook is the 4Tx codebook from LTE Rel-8 DL, LTE Rel-10 UL or NR Rel-15 DL or UL. In some embodiments, the second codebook is the 4Tx codebook from LTE Rel-8 DL. LTE Rel-10 UL or NR Rel-15 DL or UL. In some variants, the first codebook and the second codebook may be the same 4Tx codebook.

In some implementations, for ν₁ and ν₂, the householder precoders from LTE Rel-8 DL codebook can be used to construct the precoder.

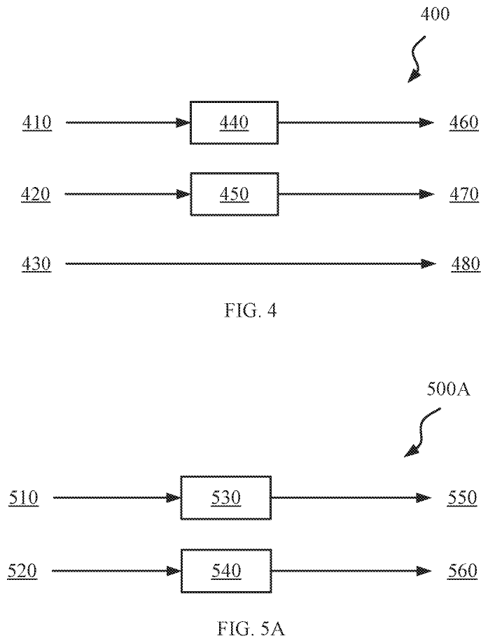

FIG. 4 illustrates a codebook design 400 in accordance with some embodiments. As depicted in FIG. 4, the precoding information comprises a first TPMI 410, a second TPMI 420, and a co-phasing indication 430 indicating the cophase 480. The first sub-precoder 460 is selected from the first codebook 440 based on the first TPMI 410 and the second sub-precoder 470 is selected from the second codebook 450 based on the second TPMI 420. In FIG. 4, TPMI 410, TMPI 420 and cophasing indication 430 are indicated in the signaling to the UE. For example, they may be contained in the precoding information and transmitted in a radio resource control (RRC), a media access control (MAC) control element (CE) or a downlink control indicator (DCI).

In some embodiments, the precoding information comprises a single new TPMI. The precoder is selected from an eight-transmitter codebook based on the new TPMI. The eight-transmitter codebook or part of the eight-transmitter codebook comprises the concatenation determined from the first sub-precoder, the second sub-precoder and the cophase. In some variants, the 8Tx codebook or part of the eight-transmitter codebook may be constructed by the same method described in FIG. 4 or other embodiments described above. The 8Tx codebook may be described/coded in the specification instead of signaling all three indicators as depicted in FIG. 4. In some variants, the new TPMI can lead to the equivalent signaling as FIG. 4. For example, for a codebook with 8×256 array, TPMI may be designed to select one out of 256.

In some embodiments, the eight-transmitter codebook further comprises at least one non-coherent precoder and/or at least one partial coherent precoder. The at least one non-coherent precoder is used for non-coherent PUSCH transmission and the at least one partial coherent precoder is used for partially coherent PUSCH transmission.

In some examples, each of the at least one non-coherent precoder is a matrix including one vector having a non-zero value in each column, and each of the at least partial coherent precoder is a matrix including one vector having two or more non-zero value in each column. For full coherent codeword, all the elements in the precoder are non-zero. For partial coherent codeword, in each column of the precoder matrix, some elements are zeroes, and some elements are non-zeroes, and the non-zero elements correspond to a coherent subgroup (e.g., for antenna ports on the same UE panel). For no-coherent codeword, in each column of the precoder matrix, only a single element is non-zero. For example, for rank 1 or 1 layer, a new codeword may be constructed like [1; 0; 0; 0; 0; 0; 0; 0] as a non-coherent codeword for non-coherent transmission, or like \sqrt{2}×[1; 0; 0; 0; 1; 0; 0; 0] as a partial coherent codeword for partially coherent transmission. In some examples, for rank 2 or 2 layers, a new codeword may be constructed like:

$$[ \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} ]$$

as a non-coherent codeword for non-coherent transmission. Higher rank or more layers for non-coherent or partially coherent codeword can be similarly constructed, which will be omitted here.

In some implementations, the new codewords constructed above can be added into the 8Tx codebook constructed by the method depicted in FIG. 4 or other embodiments described above.

In some embodiments, the two antenna panels of the UE face a same direction, the precoding information comprises a TPMI and a co-phasing indication indicating the cophase, the first sub-precoder is selected from the first codebook based on the TPMI and the second sub-precoder is the same as the first precoder. For example, when choosing the sub-precoders (e.g., the first sub-precoder and the second sub-precoder), if the two antenna panels face the same direction, a same sub-precoder can be used for both the first sub-precoder and the second sub-precoder, signaling overhead can be saved by signaling the selection of a sub-precoder instead of two separate sub-precoders. In some examples, if the two antenna panels face different directions, e.g., the first panel faces east and the second panel faces north-east, then different sub-precoders may be chosen as the first sub-precoder and the second sub-precoder, respectively.

In some implementations, the 8Tx codebook may be constructed from a Kronecker product of two codewords. In some examples, the first codebook is a four-transmitter codebook and the second codebook is a two-transmitter codebook, the 8Tx precoder is a Kronecker product of the first sub-precoder and the second sub-precoder. For example, the precoder can be constructed as ν_{2×1}⊗w_{4×1} or w_{4×1}⊗ν_{2×1}.

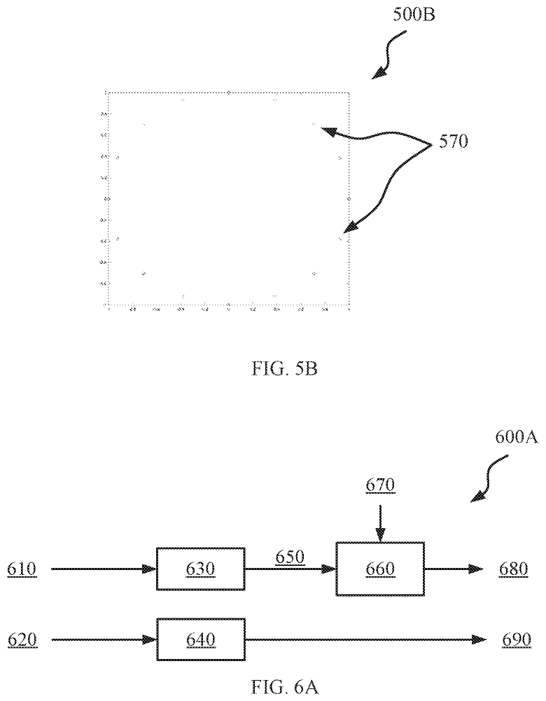

FIG. 5A illustrates another codebook design 500A in accordance with some embodiments. As shown in FIG. 5A, the precoding information comprises a first TPMI 510, a second TPMI 520, the first sub-precoder 550 is determined from the first codebook 530 based on the first TPMI 510 the second sub-precoder 560 is selected from the second codebook 540 based on the second TPMI 520. In some example, the first sub-precoder 550 is selected from the first codebook 530 based on the first TPMI 510.

In some implementations, as the 2Tx code's (e.g., codebook 540) phase representation is coarse (l, j, −l, −j), a finer phase can be used. In some examples, a phase representation of the two-transmitter codebook is determined from a 8 Phase Shift Keying (PSK) or a 16 PSK. FIG. 5B illustrates another codebook design 500B in accordance with some embodiments. As shown in FIG. 5B, phases like 570 from 16 PSK are shown. In some examples, a finer phase set for 2Tx codebook may be set as [1; x], where x is from 8PSK or 16 PSK constellations.

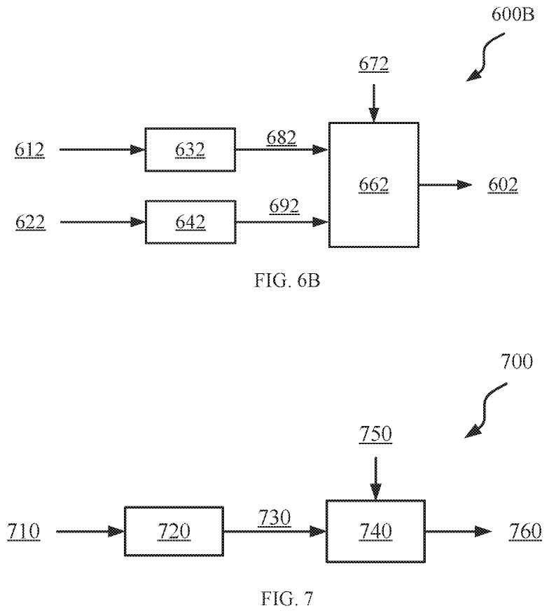

FIG. 6A illustrates another codebook design 600A in accordance with some embodiments. As shown in FIG. 6A, the precoding information comprises a first TPMI 610, a second TPMI 620, and further comprises a permutation indication 670 indicating a permutation matrix. The first sub-precoder 680 is determined by applying the permutation matrix to a first sub-precoder candidate 650, the first sub-precoder candidate 650 is selected from the first codebook 630 based on the first TPMI 610. The second sub-precoder 690 is selected from the second codebook 640 based on the second TPMI 620. In some examples, the permutation matrix is selected from a plurality of permutation matrices 660 based on the permutation indication 670.

In some variants, the first sub-precoder candidate 650 is selected from a 4Tx codebook 630 and expressed as w_{a×q}, the second sub-precoder 660 is selected from a 2Tx codebook 640 and expressed as ν_{2×p}, the precoder is constructed as ν_{2×p}⊗Πₖ(w_{4×q}) or Πₖ(w_{4×q})⊗ν_{2×p}, where k is the permutation indication 670. For example, the plurality of permutation matrices 660 may comprise Π₁(.), Π₂(.), . . . , Πₖ(.), . . . , Π_{M}(.). The permutation indication 670 (e.g., k) determines the permutation matrix (e.g., Πₖ(.)).

In some embodiments, the applying the permutation matrix to the first sub-precoder candidate 650 comprises applying the permutation matrix to rows of the first sub-precoder candidate 650, applying the permutation matrix to columns of the first sub-precoder candidate 650, or applying the permutation matrix to the rows and the columns of the first sub-precoder candidate 650. For example, the permutation matrix is applied to rows of w_{4×q}. In some examples, the permutation matrix is applied to the columns of w_{4×q}, in order to facilitate the BS (e.g., gNB)'s choice of grouping spatial layers. In some examples, the permutation matrix is applied to the rows and columns of w_{4×q}.

FIG. 6B illustrates another codebook design 600B in accordance with some embodiments. As shown in FIG. 6B, the precoder 602 is determined by applying the permutation matrix to the Kronecker product of the first sub-precoder 682 and the second sub-precoder 692, the precoder is constructed as Πₖ(ν_{2×p}⊗w_{4×q}) or Πₖ(w_{4×q}⊗ν_{2×p}), where k is the permutation indication 672, the first sub-precoder 682 is selected from a 4Tx codebook 632 based on TPMI 612 and the second sub-precoder 692 is selected from a 2Tx codebook 642 based on TPMI 622. The determination of the permutation matrix is similar to FIG. 6A, which will not be repeated here.

In some embodiments, the applying the permutation matrix to the Kronecker product of the first sub-precoder 682 and the second sub-precoder 692 comprises applying the permutation matrix to rows of the Kronecker product, applying the permutation matrix to columns of Kronecker product, or applying the permutation matrix to the rows and the columns of Kronecker product.

In some implementations, for w_{4×q} the householder precoders from LTE Rel-8 DL codebook can be used to construct the precoder.

In some embodiments, the precoding information comprises a TPMI, wherein a precoder candidate is selected from an eight-transmitter codebook based on the TPMI, and wherein the precoder is determined by applying a permutation matrix to the precoder candidate. In some example, the 8Tx codebook may comprise the codebook constructed according to the embodiments described above. In some examples, the permutation matrix is applied to the NR Rel-15 DL 8Tx codebook or Rel-15 DL 8Tx codebook with change to the oversampling factors O₁/O₂. In addition, spatial beam selection for rank I can be limited to 1 (L=1)

In some variants, permutation can be supported in a number of ways in the specification. In some examples, a number of permutations are hard-coded in the codebook construction, In some other variants, a number of allowed permutations can be RRC/MAC CE configured by the gNB. In some other variants, if the resulted codeword's number is more than the dynamic signaling can indicate (e.g., in a single stage UL DCL or two stage DCIs), then a permutation can be semi-statically indicated by MAC CE, or indicated by DCI.

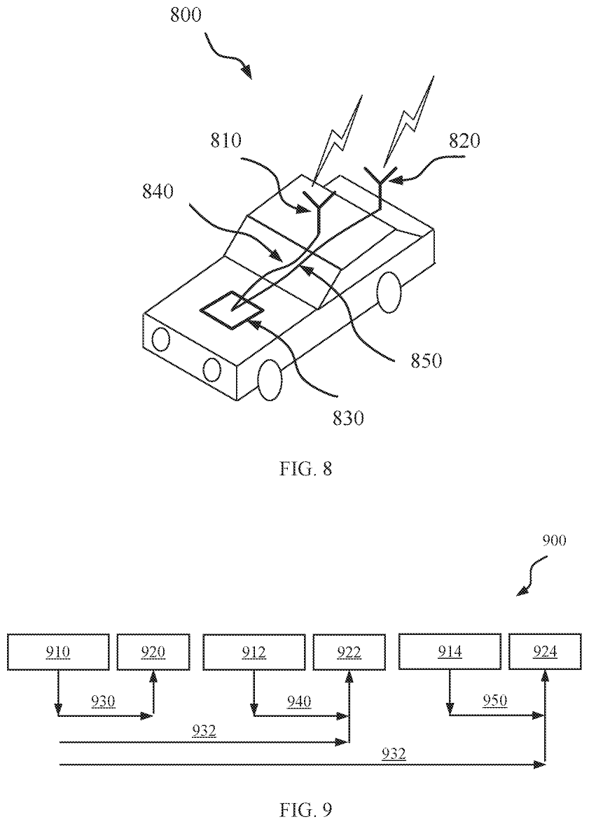

FIG. 7 illustrates another codebook design 700 in accordance with some embodiments. As shown in FIG. 7, the precoding information comprise TPMI 710 and a permutation indication 750. A precoder candidate 730 is selected from the 8Tx codebook 720 based on TPMI 710. A permutation indication 750 indicates permutation matrix from a plurality of permutation matrix 740. The precoder 760 is determined by applying the permutation matrix 740 to the precoder candidate 730.

In some implementations, the applying the permutation matrix to the precoder candidate 730 comprises applying the permutation matrix to rows of the precoder candidate 730, applying the permutation matrix to columns of the precoder candidate 730, or applying the permutation matrix to the rows and the columns of the precoder candidate 730. In some examples, the permutation matrix is {1, 3, 2, 4, 5, 6, 7, 8}. In some other examples, the permutation matrix is {2, 4, 6, 8, 1, 3, 5, 7}.

In some embodiments, the eight antenna ports of the UE are of a same polarization, and the precoder is determined from a two-stage codebook comprising a first precoding matrix and a second precoding matrix. In some examples, the UE is a vehicle. In some variants, depending on the locations where antennas are installed on the vehicle, all the antennas are vertical polarization, which is breaking away from the conventional cross-pol antenna assumption for base station.

In some embodiments, the eight antenna ports of the UE are facing a same direction, and the first precoding matrix is a beam group determined by Direct Fourier Transform (DFT) beams of the eight antenna ports. In some examples, if two stage codebook design is used, then W₁ is modified as W₁=B, where B consists of DFT beams b₁, b₂, . . . , b_{L}. In contrast in related Rel-15/16/17 codebook design excluding portion selection codebooks, the W construction for downlink codebooks is W₁=[B 0; 0 B]=diag(B, B).

In some embodiments, the eight antenna ports comprise a plurality of antenna panels facing different directions. The first precoding matrix is a block diagonal matrix, each block of the main diagonal of the block diagonal matrix is associated with a corresponding antenna panel of the plurality of antenna panels. In some examples, if two stage codebook design is used, then all the antenna ports are not necessarily facing the same direction, then W₁ is modified as: W₁=[B₁0; 0 B₂]=diag(B₁, B₂) or W₁=diag(B₁, B₂, B₃, B₄), which essentially allow different spatial beam basis selection for different antenna panels.

For vehicle UEs, it may be possible the cables connecting antennas/antenna panels to the baseband module may have different length. Problems may be encountered in practice: For carrier frequency at 3.5 GHz, 100 MHz channel BW, separation of 2 meters between antenna panels. For Wavelength: 3e8/3.5e9=0.085 meters. Propagation delay difference at 2 meters can induce phase change over 100 MHz, e.g., constructive addition between signals emitted from two panels at 3.5 GHz, but deep nulls due to cancelation between signals emitted from panels at some frequencies between 3.5 GHz and 3.6 GHz (3.5 GHz+100 MHz=3.6 GHz).

In some embodiments, the eight antenna ports comprise a plurality of antenna panels, each of the plurality of antenna panels is associated with a corresponding precoder. Each pair of two antenna panels of the plurality of antenna panels is associated with a corresponding adjustment parameter for adjusting an amplitude and a phase between the pair of two antenna panels, and a corresponding compensation of a propagation delay between the pair of two antenna panels. The precoder is determined based on all corresponding precoders, all corresponding adjustment parameters and all corresponding compensations.

FIG. 8 illustrates an antenna configuration scenario 800 in accordance with some embodiments. As depicted in FIG. 8, a pair of antenna/antenna panel 810 and antenna/antenna panel 820 are configured on the vehicle. The antennas/antenna panels 810 and 820 are connected with baseband 830 through cables 840 and 850, respectively. Due to the different configuration of the antennas/antenna panels on the vehicle UEs, a length difference exist between the cable 840 and cable 850. Note that the number and position of the antennas/antenna panels and the baseband shown in FIG. 8 is only for illustrative purpose, and it is not intended to limit the scope of this disclosure.

In some examples, with two antennas/antenna panels, one codebook design is to formulate the precoder as U₁+U₁βe^{2 πτƒ}, where U₁, U₂ are the precoders applied to different panels, β is for amplitude and phase adjustment between two panels (e.g., the amplitude and phase adjustment between the pair of two antenna panels 810 and 820), τ is for the compensation of the propagation delay difference between UE panels with respect to the base station (e.g., the propagation delay difference caused by length difference between cables 840 and 850), ƒ can be the carrier frequency at a tone, a PRB, a subband consisting of PRBs. In some variants, the two panels have the same number of antenna ports, the U₁ may have half of its rows being zeroes, and U₂ may have half of its rows being zeroes. In some variants, β may be zero.

In some embodiments, the precoding information comprise a corresponding TPMI, the corresponding adjustment parameter and the corresponding compensation. The corresponding TPMI indicates the corresponding precoder. In some examples, the precoding information is separately configured in a RRC, a MAC CE, or a DCI. In some examples, U₁, U₂, β, τ can be signaled to the UE for uplink transmission, they may not be signaled at the same time, e.g., U₁, U₂ are precoding vectors/matrices for antenna modules/panels are signaled more frequently than τ, etc., and they can be signaled separated through MAC CE, DCI(s). In some embodiments, U₁, U₂ may be the codebooks constructed according to the embodiments described above.

In some embodiments, there are more than one antenna panels (K), then the precoder may be determined as:

$${{\sum }^{K}}_{k = 1} {U}_{k} {β}_{k} {e}^{2 {πτ}_{k} f}$$

τₖ is for the compensation of the propagation delay difference among UE panels with respect to the base station, a reference UE panel is used in their determination, for example UE panel 1 (the first group of antenna ports). Equivalently, τₖ can be formed as the ratio of a distance between panels and the speed of light.

In some embodiments, the precoding information comprises a sounding reference signal resource indicator (SRI), the SRI indicates one or more SRS resources for the codebook-based PUSCH transmission.

In some implementations, the one or more SRS resources comprise a single SRS resource for the codebook-based PUSCH transmission with the eight antenna ports. For example, a single SRS resource with 8 SRS ports is indicated for a given PUSCH.

In some implementations, SRS resources comprise two or more SRS resources, the eight antenna ports comprise two or more antenna panels corresponding to the two or more SRS resources The SRI comprises additional bits for selecting panels from the two or more antenna panels used in the codebook-based PUSCH. In some examples, multiple (e.g., 2) SRS resources with fewer than 8 SRS ports (e.g., 4) are indicated, and SRS resource corresponds roughly to UE panel. In some examples, if more than 2 SRS resources are supported by the UE, with 4 ports at each SRS resources, the total number of ports over all SRS resources exceeds 8, then panel selection is supported. For example, assuming there are 3 SRS resource in total, SRS resources 1 and 2 corresponding to panels {1, 2} are indicated. For another example, SRS resources 1 and 3 corresponding to panels {1, 3} are indicated. Given the number of SRS resources (N_{SRS-Resources}), the selection of SRS resources can take the form of nchoosek(N_{SRS-Resources}, 2) if the number of antenna ports per SRS resource is 4, or nchoosek(N_{SRS-Resources}, 4) if the number of antenna ports per SRS resource is 2, and so on. As the number of combinations from nchoosek(N_{SRS-Resources}, N_{selected-SRS-Resources}) can be be large, some combinations may not be be supported so the number of allowable combinations is limited and corresponding signaling overhead for SRI(s) is smaller.

In some implementations, the additional bits comprise a combinatorial index or a bitmap. For example, a combinatorial index C(3,2) is used, C (3,2)=3 code states, which means the ceil bits is log₂³=2 bits (or log2(3)=2 bits). In the combinatorial index, for example, “00” is for [0 1 1], meaning the second and the third panels are indicated; “01” is for [1 0 1], meaning the first and the third panels are indicated; “10” is for [1 1 0], meaning the first and the second panels are indicated. In some variants, a bitmap (e.g., 3 bits) may be used. For example, [1 1 0] means the first and the second panels are indicated; [1 0 1] means the first and the third panels are indicated.

In some example, the SRI(s) is indicated in a MAC-CE.

In some embodiments, the precoder is a two-stage codebook comprising a first precoding matrix W₁ and a second precoding matrix W₂, the precoding information indicates the first precoding matrix W₁ and the second precoding matrix W₂. In some examples, if two stage codebook is adopted for 8Tx UL, the signaling overhead to indicate both W₁ and W₂ may be too much, even if only wideband precoding is used (hence a single W₂ is applied to wideband).

In some implementations, W₁ is indicative of the general beam direction and can be more stable than W₂. In some options, W₁ and W₂ may be signaled at different time spans/intervals/with different means. In some examples, both the first precoding matrix W₁ and the second precoding matrix W₂ are dynamically indicated/indicated in a dynamical signaling (e.g., in a DCI). In some examples, to save signaling overhead, an indicator (e.g., 1 bit indicator) is introduced in the DCI to indicates whether the DCI is used to update the first precoding matrix W₁ or the second precoding matrix W₂.

In some implementations, both the first precoding matrix and the second precoding matrix are dynamically indicated (e.g., in a DCI). In some examples, the code state of W₁ signaling and W₂ signaling are shared. In some options, the DCI comprises a number of bits creating a plurality of code states, a first number of the code states indicate the first precoding matrix W₁ and a second number of the code states indicate the second precoding matrix W₂, and a sum of the first number and the second number is less than or equal to a number of the code states. For example, with B bits, up to 2\hat{ }B code states are created, and A₁ states are for W₁ signaling, and A₂ states are for W₂ signaling, and A₁+A₂≤2 \hat{ }B. In some variants, when W₁ signaling is received by the UE, a default W₂ can be assumed. For example, for rank 1:

$${W}_{2} = {[ 1 ; \underbrace{0 ; … ; 0} ]}_{2 L - 1 or L - 1} ,$$

where L represents rank, when W₁ is constructed as W₁ =B as described above, there are L-1 zeros in W₂, and when W₁ is constructed as W₁=[B 0; 0 B]=diag(B, B), there are 2L-1 zeros in W₂.

For another example, for rank 2:

$${W}_{2} = {[ 10 …0 ; 01 …0 ]}^{T}$$

The similar construction used in rank 1 is applied for each column of rank 2 W₂, and it will not be repeated here.

In some embodiments, both the first precoding matrix W, and the second precoding matrix W₂ are dynamically indicated (e.g., in a DCI), the first precoding matrix is selected from a group of first precoding matrix candidates, and the second precoding matrix is selected from a first group of second precoding matrix candidates or a second group of second precoding matrix candidates. In some examples, the DCI comprises a number of bits creating a plurality of code states, a first number of the code states indicate the first precoding matrix and the second precoding matrix selected from the first group of second precoding matrix candidates, a second number of the code states indicate the second precoding matrix selected from the second group of second precoding matrix candidates, the number of bits is determined by the first number and the second number.

In some variants, the code states of W₁ signaling and W₂ are jointly designed. In some examples, some code states for joint W₁/W₂ signaling. In some options, only a small number of W₂ is allowed when signalled together with W₁. Some code states are for W₂ only signaling. For example, with joint W₁/W₂ signaling, arbitrary pairing of m₁ choices (e.g., a group of first precoding matrix candidates) for W₁ and m₂ choices (e.g., a first group of second precoding matrix candidates) for W₂ is allowed. In total, C_{1,2}=m₁×m₂ code states are needed for indicating them. For example, for rank 1, a small set for

$${W}_{2} = {[ 1 ; \underbrace{0 ; … ; 0} ]}_{2 L - 1 or L - 1} ,$$

$$or$$

$${W}_{2} = {[ 0 ; 1 ; \underbrace{0 ; … ; 0} ]}_{2 L - 2 or L - 2} , etc .$$

For rank 2, a small set for W₂=[10 . . . 0; 0 1 . . . 0]^{T}, or W₂=[0 10 . . . 0; 0 0 1 . . . 0]^{T}, etc.

In some options, with W₂ only signaling, m₃ choices (e.g., the second group of second precoding matrix candidates) are provided. In total, ceil (log₂^{(C}^{_{1,2}}^{+m}^{₃}) bits are needed to indicate a code state in dynamic signaling.

In some implementations, in response to a pair of the first precoding matrix W₁ and the second precoding matrix W₂ selected from the first group of second precoding matrix candidates is not supported, a code state represented by the pair is reduced from the first number of the code states (e.g., m₁×m₂). For example, if not all pairing of m₁ choices for W₁, and m₂ choices for W₂ are supported, then the code state number of joint W₁/W₂ signaling is fewer (that is, the unsupported code stated represented by the pair is reduced from the first number of the code states), e.g., C_{1,2}<m₁×m₂.

In some embodiments, the first precoding matrix W₁ is indicated less frequently than the second precoding matrix W₂.

FIG. 9 illustrates a signaling design 900 in accordance with some embodiments. As shown in FIG. 9, some code states are for the joint signaling of W₁ and W₂. Dynamic signaling 910 indicates a code state for joint signaling of W₁ and W₂. With precoder 930 (determined from W₁ and W₂ that both are indicated by dynamic signaling 910), UE performs PUSCH transmission 920. In another transmission after dynamic signaling 910, dynamic signaling 912 indicates a code state for the signaling of only W₂ to UE. UE determines precoder 940 based on W₁ 932 from the dynamic signaling 910 and W₂ from the dynamic signaling 912, and performs PUSCH transmission 922. In still another transmission after dynamic signaling 910, dynamic signaling 914 indicates a code state for the signaling of only W₂ to UE. UE determines precoder 950 based on W₁ 932 from the dynamic signaling 910 and W₂ from the dynamic signaling 914, and performs PUSCH transmission 924.

In some embodiments, the first precoding matrix W₁ is indicated in a MAC CE and the second precoding matrix W₂ is indicated in a dynamical signaling. FIG. 10 illustrates another signaling design 1000 in accordance with some embodiments. As depicted in FIG. 10, W₁ signaling can be carried in an MAC CE 1010 and W₂ signaling is dynamically indicated in 1030, e.g., in a DCI, such design can reduce feedback overhead. In some examples, the preferred UE panel or preferred UE panels does not change. In some examples, if UE panel selection is supported as described above in the embodiments relating to the design of SRI(s), the SRI(s) indication can be expanded to cover the signaling of multiple panels, and SRI indication can be carried in MAC CE as well.

In some embodiments, the first precoding matrix W₁ is indicated in a MAC CE or a dynamical signaling to support open-loop uplink transmission, the second precoding matrix W₂ is selected from a group of second precoding matrix candidates during each repetition of the codebook-based PUSCH transmission for PUSCH with repetition. In some variants, one possible alternative for PUSCH repetitions is to indicate W₁ only to support open-loop transmission, where UE can apply different W₂ at different repetitions. For 8Tx, open-loop transmission scheme may become more effective as the beam becomes narrower.

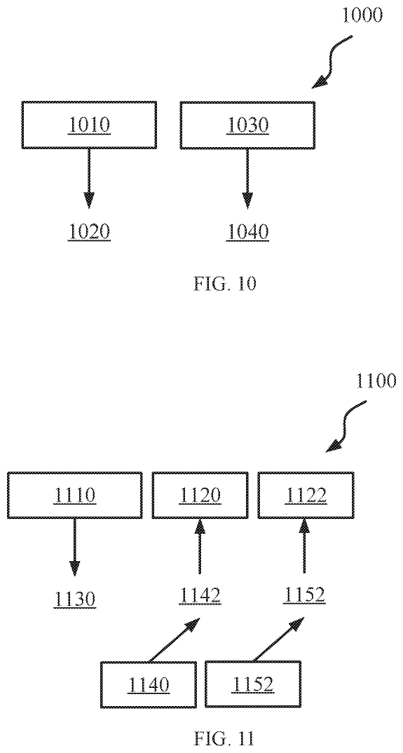

FIG. 11 illustrates another signaling design 1100 in accordance with some embodiments. As shown in FIG. 11, the UE performs semi-open-loop uplink transmission. The first precoding matrix W₁ 1130 is indicated in 1110, 1110 may be a MAC CE or a dynamical signaling like DCI. UE performs PUSCH repetitions by selecting W₂ from a group of second precoding matrix candidates. In some examples, UE selects W₂ 1140, combining with W₁ 1130, UE determines the precoder 1142, and performs the PUSCH repetition 1120. In other examples, UE selects W₂ 1150, combining with W₁ 1130, UE determines the precoder 1152, and performs the PUSCH repetition 1122.

In some implementations, the codebook-based PUSCH is a configured grant (CG) PUSCH, wherein the precoding information is indicated through MAC CE or DCI to update the precoder. In some examples, for CG-PUSCH, some lower layer signaling may be used to update the TPMI. In some variants, the best precoder may change more frequently for 8Tx. In some examples, MAC CE, DCI may be used to update the precoder, including W₁ only, W₂ only, both W₁ and W₂ if two stage codebook is used.

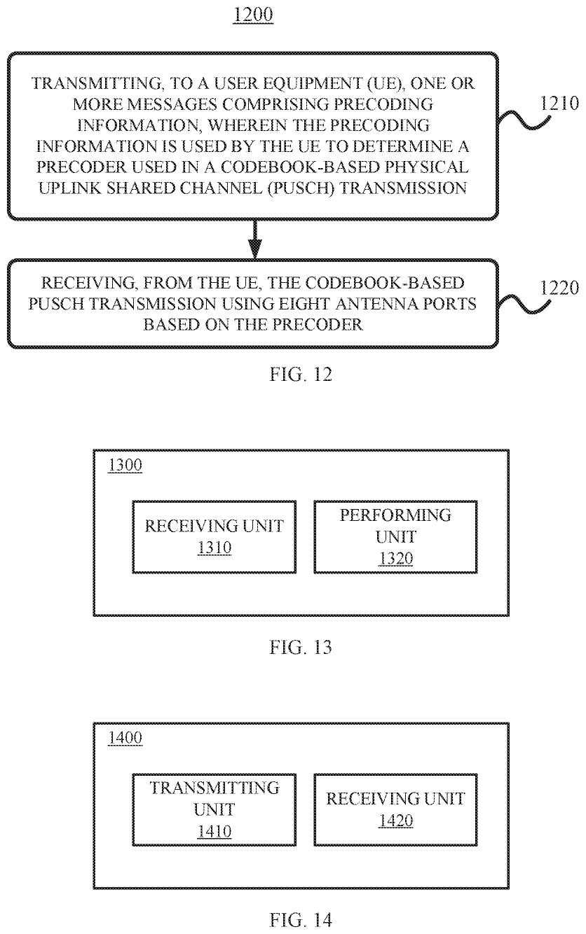

FIG. 12 illustrates a flowchart for a method 1200 performed by a BS in accordance with some embodiments. As shown in FIG. 12, method 1200 comprises step 1210 and step 1220.

In step 1210, a based station (BS) transmits, to a user equipment (UE), one or more messages comprising precoding information, the precoding information is used by the UE to determine a precoder used in a codebook based Physical Uplink Shared Channel (PUSCH) transmission.

In step 1220, the BS receives, from the UE, the codebook-based PUSCH transmission using eight antenna ports based on the precoder.

FIG. 13 illustrates a block diagram of an apparatus 1300 for a UE in accordance with some embodiments. As shown in FIG. 13, apparatus 1300 comprises receiving unit 1310 and performing unit 1320. The receiving unit 1310 is configured to receive, from a base station (BS), one or more messages comprising precoding information, the precoding information is used by the UE to determine a precoder used in a codebook based Physical Uplink Shared Channel (PUSCH) transmission. The performing unit 1320 is configured to perform the codebook-based PUSCH transmission using eight antenna ports based on the precoder.

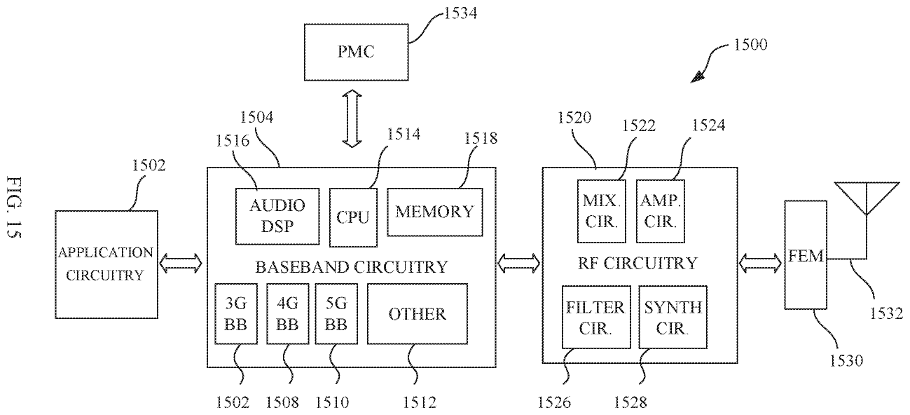

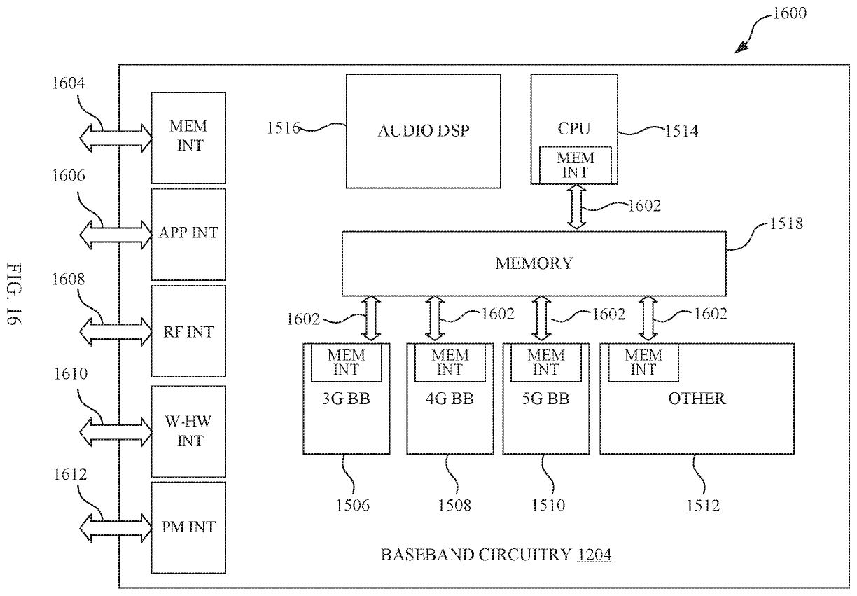

FIG. 14 illustrates a block diagram of an apparatus 1400 for a communication network in accordance with some embodiments. As shown in FIG. 14, apparatus 1400 comprises transmitting unit 1410 and receiving unit 1420. The transmitting unit 1410 is configured to transmit, to a user equipment (UE), one or more messages comprising precoding information, the precoding information is used by the UE to determine a precoder used in a codebook based Physical Uplink Shared Channel (PUSCH) transmission. The receiving unit 1420 is configured to receive, from the UE, the codebook-based PUSCH transmission using eight antenna ports based on the precoder.

It should be note that the terms “precoder”, “codeword” and “codebook” are interchangeable, and that the terms “permutation” and “permutation matrix” are interchangeable throughout this disclosure.

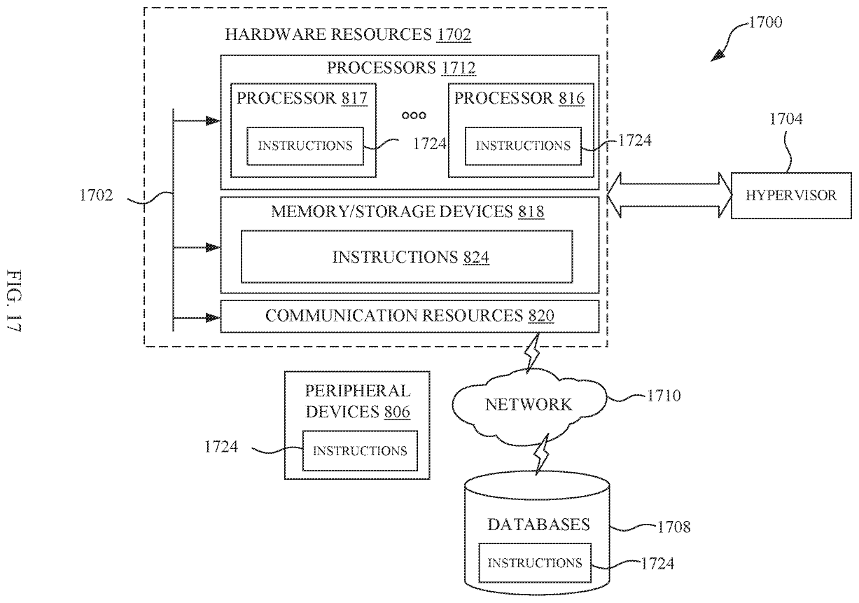

FIG. 15 illustrates example components of a device 1500 in accordance with some embodiments. In some embodiments, the device 1500 may include application circuitry 1502, baseband circuitry 1504, Radio Frequency (RF) circuitry (shown as RF circuitry 1520), front-end module (FEM) circuitry (shown as FEM circuitry 1530), one or more antennas 1532, and power management circuitry (PMC) (shown as PMC 1534) coupled together at least as shown. The components of the illustrated device 1500 may be included in a UE or a RAN node. In some embodiments, the device 1500 may include fewer elements (e.g., a RAN node may not utilize application circuitry 1502, and instead include a processor/controller to process IP data received from an EPC). In some embodiments, the device 1500 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1502 may include one or more application processors. For example, the application circuitry 1502 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1500. In some embodiments, processors of application circuitry 1502 may process IP data packets received from an EPC.

The baseband circuitry 1504 may include circuitry such as, but not limited to, one or more single-core or multi-core processors. The baseband circuitry 1504 may include one or more baseband processors or control logic to process baseband signals received from a receive signal path of the RF circuitry 1520 and to generate baseband signals for a transmit signal path of the RF circuitry 1520. The baseband circuitry 1504 may interface with the application circuitry 1502 for generation and processing of the baseband signals and for controlling operations of the RF circuitry 1520. For example, in some embodiments, the baseband circuitry 1504 may include a third generation (3G) baseband processor (3G baseband processor 1506), a fourth generation (4G) baseband processor (4G baseband processor 1508), a fifth generation (5G) baseband processor (5G baseband processor 1510), or other baseband processor(s) 1512 for other existing generations, generations in development or to be developed in the future (e.g., second generation (2G), sixth generation (6G), etc.). The baseband circuitry 1504 (e.g., one or more of baseband processors) may handle various radio control functions that enable communication with one or more radio networks via the RF circuitry 1520. In other embodiments, some or all of the functionality of the illustrated baseband processors may be included in modules stored in the memory 1518 and executed via a Central Processing ETnit (CPET 1514). The radio control functions may include, but are not limited to, signal modulation/demodulation, encoding/decoding, radio frequency shifting, etc. In some embodiments, modulation/demodulation circuitry of the baseband circuitry 1504 may include Fast-Fourier Transform (FFT), precoding, or constellation mapping/demapping functionality. In some embodiments, encoding/decoding circuitry of the baseband circuitry 1504 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1504 may include a digital signal processor (DSP), such as one or more audio DSP(s) 1516. The one or more audio DSP(s) 1516 may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1504 and the application circuitry 1502 may be implemented together such as, for example, on a system on a chip (SOC).

In some embodiments, the baseband circuitry 1504 may provide for communication compatible with one or more radio technologies. For example, in some embodiments, the baseband circuitry 1504 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 1504 is configured to support radio communications of more than one wireless protocol may be referred to as multi-mode baseband circuitry.

The RF circuitry 1520 may enable communication with wireless networks using modulated electromagnetic radiation through a non-solid medium. In various embodiments, the RF circuitry 1520 may include switches, filters, amplifiers, etc. to facilitate the communication with the wireless network. The RF circuitry 1520 may include a receive signal path which may include circuitry to down-convert RF signals received from the FEM circuitry 1530 and provide baseband signals to the baseband circuitry 1504. The RF circuitry 1520 may also include a transmit signal path which may include circuitry to up-convert baseband signals provided by the baseband circuitry 1504 and provide RF output signals to the FEM circuitry 1530 for transmission. [0151] In some embodiments, the receive signal path of the RF circuitry 1520 may include mixer circuitry 1522, amplifier circuitry 1524 and filter circuitry 1526. In some embodiments, the transmit signal path of the RF circuitry 1520 may include filter circuitry 1526 and mixer circuitry 1522. The RF circuitry 1520 may also include synthesizer circuitry 1528 for synthesizing a frequency for use by the mixer circuitry 1522 of the receive signal path and the transmit signal path. In some embodiments, the mixer circuitry 1522 of the receive signal path may be configured to down-convert RF signals received from the FEM circuitry 1530 based on the synthesized frequency provided by synthesizer circuitry 1528. The amplifier circuitry 1524 may be configured to amplify the down-converted signals and the filter circuitry 1526 may be a low-pass filter (LPF) or band-pass filter (BPF) configured to remove unwanted signals from the down-converted signals to generate output baseband signals. Output baseband signals may be provided to the baseband circuitry 1504 for further processing. In some embodiments, the output baseband signals may be zero-frequency baseband signals, although this is not a requirement. In some embodiments, the mixer circuitry 1522 of the receive signal path may comprise passive mixers, although the scope of the embodiments is not limited in this respect.

In some embodiments, the mixer circuitry 1522 of the transmit signal path may be configured to up-convert input baseband signals based on the synthesized frequency provided by the synthesizer circuitry 1528 to generate RF output signals for the FEM circuitry 1530. The baseband signals may be provided by the baseband circuitry 1504 and may be filtered by the filter circuitry 1526.

In some embodiments, the mixer circuitry 1522 of the receive signal path and the mixer circuitry 1522 of the transmit signal path may include two or more mixers and may be arranged for quadrature downconversion and upconversion, respectively. In some embodiments, the mixer circuitry 1522 of the receive signal path and the mixer circuitry 1522 of the transmit signal path may include two or more mixers and may be arranged for image rejection (e.g., Hartley image rejection). In some embodiments, the mixer circuitry 1522 of the receive signal path and the mixer circuitry 1522 may be arranged for direct downconversion and direct upconversion, respectively. In some embodiments, the mixer circuitry 1522 of the receive signal path and the mixer circuitry 1522 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1520 may include analog-to-digital converter (ADC) and digital-to-analog converter (DAC) circuitry and the baseband circuitry 1504 may include a digital baseband interface to communicate with the RF circuitry 1520.

In some dual-mode embodiments, a separate radio IC circuitry may be provided for processing signals for each spectrum, although the scope of the embodiments is not limited in this respect.

In some embodiments, the synthesizer circuitry 1528 may be a fractional-N synthesizer or a fractional N/N+1 synthesizer, although the scope of the embodiments is not limited in this respect as other types of frequency synthesizers may be suitable. For example, synthesizer circuitry 1528 may be a delta-sigma synthesizer, a frequency multiplier, or a synthesizer comprising a phase-locked loop with a frequency divider.

The synthesizer circuitry 1528 may be configured to synthesize an output frequency for use by the mixer circuitry 1522 of the RF circuitry 1520 based on a frequency input and a divider control input. In some embodiments, the synthesizer circuitry 1528 may be a fractional N/N+1 synthesizer.

In some embodiments, frequency input may be provided by a voltage controlled oscillator (VCO), although that is not a requirement. Divider control input may be provided by either the baseband circuitry 1504 or the application circuitry 1502 (such as an applications processor) depending on the desired output frequency. In some embodiments, a divider control input (e.g., N) may be determined from a look-up table based on a channel indicated by the application circuitry 1502.

Synthesizer circuitry 1528 of the RF circuitry 1520 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1528 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1520 may include an IQ/polar converter.

The FEM circuitry 1530 may include a receive signal path which may include circuitry configured to operate on RF signals received from one or more antennas 1532, amplify the received signals and provide the amplified versions of the received signals to the RF circuitry 1520 for further processing. The FEM circuitry 1530 may also include a transmit signal path which may include circuitry configured to amplify signals for transmission provided by the RF circuitry 1520 for transmission by one or more of the one or more antennas 1532. In various embodiments, the amplification through the transmit or receive signal paths may be done solely in the RF circuitry 1520, solely in the FEM circuitry 1530, or in both the RF circuitry 1520 and the FEM circuitry 1530.

In some embodiments, the FEM circuitry 1530 may include a TX/RX switch to switch between transmit mode and receive mode operation. The FEM circuitry 1530 may include a receive signal path and a transmit signal path. The receive signal path of the FEM circuitry 1530 may include an LNA to amplify received RF signals and provide the amplified received RF signals as an output (e.g., to the RF circuitry 1520). The transmit signal path of the FEM circuitry 1530 may include a power amplifier (PA) to amplify input RF signals (e.g., provided by the RF circuitry 1520), and one or more filters to generate RF signals for subsequent transmission (e.g., by one or more of the one or more antennas 1532).

In some embodiments, the PMC 1534 may manage power provided to the baseband circuitry 1504. In particular, the PMC 1534 may control power-source selection, voltage scaling, battery charging, or DC-to-DC conversion. The PMC 1534 may often be included when the device 1500 is capable of being powered by a battery, for example, when the device 1500 is included in a EGE. The PMC 1534 may increase the power conversion efficiency while providing desirable implementation size and heat dissipation characteristics.

FIG. 15 shows the PMC 1534 coupled only with the baseband circuitry 1504. However, in other embodiments, the PMC 1534 may be additionally or alternatively coupled with, and perform similar power management operations for, other components such as, but not limited to, the application circuitry 1502, the RF circuitry 1520, or the FEM circuitry 1530.

In some embodiments, the PMC 1534 may control, or otherwise be part of, various power saving mechanisms of the device 1500. For example, if the device 1500 is in an RRC Connected state, where it is still connected to the RAN node as it expects to receive traffic shortly, then it may enter a state known as Discontinuous Reception Mode (DRX) after a period of inactivity. During this state, the device 1500 may power down for brief intervals of time and thus save power.

If there is no data traffic activity for an extended period of time, then the device 1500 may transition off to an RRC Idle state, where it disconnects from the network and does not perform operations such as channel quality feedback, handover, etc. The device 1500 goes into a very low power state and it performs paging where again it periodically wakes up to listen to the network and then powers down again. The device 1500 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1502 and processors of the baseband circuitry 1504 may be used to execute elements of one or more instances of a protocol stack. For example, processors of the baseband circuitry 1504, alone or in combination, may be used to execute Layer 3, Layer 2, or Layer 1 functionality, while processors of the application circuitry 1502 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer I may comprise a physical (PHY) layer of a UE/RAN node, described in further detail below.

FIG. 16 illustrates example interfaces 1600 of baseband circuitry in accordance with some embodiments. As discussed above, the baseband circuitry 1504 of FIG. 15 may comprise 3G baseband processor 1506, 4G baseband processor 1508, 5G baseband processor 1510, other baseband processor(s) 1512, CPU 1514, and a memory 1618 utilized by said processors. As illustrated, each of the processors may include a respective memory interface 1602 to send/receive data to/from the memory 1618.

The baseband circuitry 1504 may further include one or more interfaces to communicatively couple to other circuitries/devices, such as a memory interface 1604 (e.g., an interface to send/receive data to/from memory external to the baseband circuitry 1604), an application circuitry interface 1606 (e.g., an interface to send/receive data to/from the application circuitry 1502 of FIG. 15), an RF circuitry interface 1608 (e.g., an interface to send/receive data to/from RF circuitry 1520 of FIG. 15), a wireless hardware connectivity interface 1610 (e.g., an interface to send/receive data to/from Near Field Communication (NFC) components, Bluetooth® components (e.g., Bluetooth® Low Energy), Wi-Fi® components, and other communication components), and a power management interface 1612 (e.g., an interface to send/receive power or control signals to/from the PMC 1534.

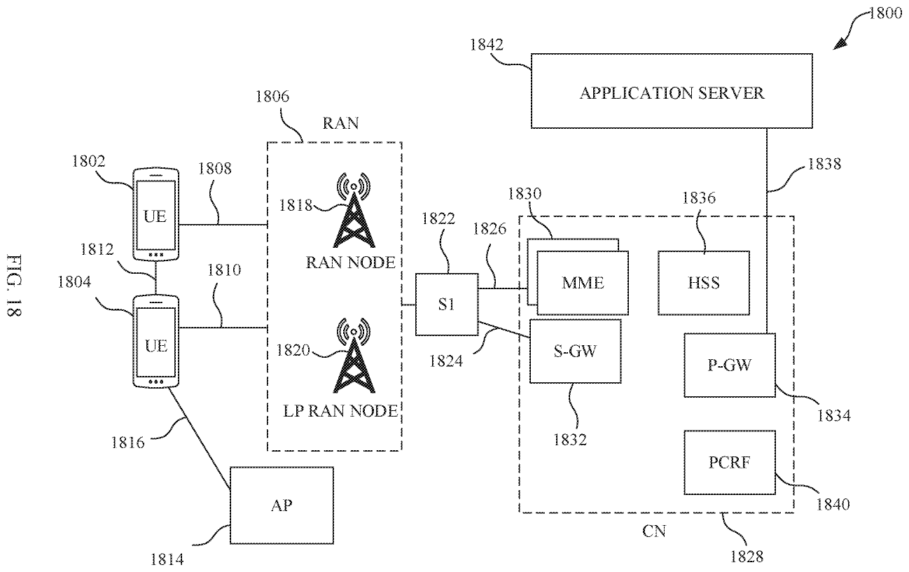

FIG. 17 is a block diagram illustrating components 1700, according to some example embodiments, able to read instructions from a machine-readable or computer-readable medium (e.g., a non-transitory machine-readable storage medium) and perform any one or more of the methodologies discussed herein. Specifically, FIG. 17 shows a diagrammatic representation of hardware resources 1702 including one or more processors 1712 (or processor cores), one or more memory/storage devices 1718, and one or more communication resources 1720, each of which may be communicatively coupled via a bus 1722. For embodiments where node virtualization (e.g., NFV) is utilized, a hypervisor 1704 may be executed to provide an execution environment for one or more network slices/sub-slices to utilize the hardware resources 1702.

The processors 1712 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1714 and a processor 1716.

The memory/storage devices 1718 may include main memory, disk storage, or any suitable combination thereof. The memory/storage devices 1718 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1720 may include interconnection or network interface components or other suitable devices to communicate with one or more peripheral devices 1706 or one or more databases 1708 via a network 1710. For example, the communication resources 1720 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1724 may comprise software, a program, an application, an applet, an app, or other executable code for causing at least any of the processors 1712 to perform any one or more of the methodologies discussed herein. The instructions 1724 may reside, completely or partially, within at least one of the processors 1712 (e.g., within the processor's cache memory), the memory/storage devices 1718, or any suitable combination thereof. Furthermore, any portion of the instructions 1724 may be transferred to the hardware resources 1702 from any combination of the peripheral devices 1706 or the databases 1708. Accordingly, the memory of the processors 1712, the memory/storage devices 1718, the peripheral devices 1706, and the databases 1708 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

FIG. 18 illustrates an architecture of a system 1800 of a network in accordance with some embodiments. The system 1800 includes one or more user equipment (UE), shown in this example as a UE 1802 and a UE 1804. The UE 1802 and the UE 1804 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UE 1802 and the UE 1104 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. [1002] The UE 1802 and the UE 1804 may be configured to connect, e.g., communicatively couple, with a radio access network (RAN), shown as RAN 1806. The RAN 1806 may be, for example, an Evolved ETniversal Mobile Telecommunications System (ETMTS) Terrestrial Radio Access Network (E-UTRAN), a NextGen RAN (NG RAN), or some other type of RAN. The UE 1802 and the UE 1804 utilize connection 1808 and connection 1810, respectively, each of which comprises a physical communications interface or layer (discussed in further detail below); in this example, the connection 1808 and the connection 1810 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1802 and the UE 1804 may further directly exchange communication data via a ProSe interface 1812. The ProSe interface 1812 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1804 is shown to be configured to access an access point (AP), shown as AP 1184, via connection 1816. The connection 1816 can comprise a local wireless connection, such as a connection consistent with any IEEE 802.18 protocol, wherein the AP 1814 would comprise a wireless fidelity (WiFi®) router. In this example, the AP 1814 may be connected to the Internet without connecting to the core network of the wireless system (described in further detail below).

The RAN 1806 can include one or more access nodes that enable the connection 1808 and the connection 1810. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 1806 may include one or more RAN nodes for providing macrocells, e.g., macro RAN node 1818, and one or more RAN nodes for providing femtocells or picocells (e.g., cells having smaller coverage areas, smaller user capacity, or higher bandwidth compared to macrocells), e.g., a low power (LP) RAN node such as LP RAN node 1820. Any of the macro RAN node 1818 and the LP RAN node 1820 can terminate the air interface protocol and can be the first point of contact for the UE 1802 and the UE 1804. In some embodiments, any of the macro RAN node 1818 and the LP RAN node 1820 can fulfill various logical functions for the RAN 1806 including, but not limited to, radio network controller (RNC) functions such as radio bearer management, uplink and downlink dynamic radio resource management and data packet scheduling, and mobility management.

In accordance with some embodiments, the EGE 1802 and the EGE 1804 can be configured to communicate using Orthogonal Frequency-Division Multiplexing (OFDM) communication signals with each other or with any of the macro RAN node 1818 and the LP RAN node 1820 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal sub carriers.

In some embodiments, a downlink resource grid can be used for downlink transmissions from any of the macro RAN node 1818 and the LP RAN node 1820 to the UE 1802 and the UE 1804, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1802 and the UE 1804. The physical downlink control channel (PDCCH) may carry information about the transport format and resource allocations related to the PDSCH channel, among other things. It may also inform the UE 1802 and the UE 1804 about the transport format, resource allocation, and H-ARQ (Hybrid Automatic Repeat Request) information related to the uplink shared channel. Typically, downlink scheduling (assigning control and shared channel resource blocks to the UE 1804 within a cell) may be performed at any of the macro RAN node 1818 and the LP RAN node 1820 based on channel quality information fed back from any of the UE 1802 and UE 1804. The downlink resource assignment information may be sent on the PDCCH used for (e.g., assigned to) each of the UE 1802 and the UE 1804.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs), Similar to above, each ECCE may correspond to nine sets of four physical resource elements known as enhanced resource element groups (EREGs). An ECCE may have other numbers of EREGs in some situations.

The RAN 1806 is communicatively coupled to a core network (CN), shown as CN 1828—via an SI interface 1822. In embodiments, the CN 1828 may be an evolved packet core (EPC) network, a NextGen Packet Core (NPC) network, or some other type of CN. In this embodiment the SI interface 1822 is split into two parts: the SI-U interface 1824, which carries traffic data between the macro RAN node 1818 and the LP RAN node 1820 and a serving gateway (S-GW), shown as S-GW 1 132, and an SI-mobility management entity (MME) interface, shown as SI-MME interface 1826, which is a signaling interface between the macro RAN node 1818 and LP RAN node 1820 and the MME(s) 1830. In this embodiment, the CN 1828 comprises the MME(s) 1830, the S-GW 1832, a Packet Data Network (PDN) Gateway (P-GW) (shown as P-GW 1834), and a home subscriber server (HSS) (shown as HSS 1836). The MME(s) 1830 may be similar in function to the control plane of legacy Serving General Packet Radio Service (GPRS) Support Nodes (SGSN). The MME(s) 1830 may manage mobility aspects in access such as gateway selection and tracking area list management. The HSS 1836 may comprise a database for network users, including subscription-related information to support the network entities' handling of communication sessions. The CN 1828 may comprise one or several HSS 1836, depending on the number of mobile subscribers, on the capacity of the equipment, on the organization of the network, etc. For example, the HSS 1836 can provide support for routing/roaming, authentication, authorization, naming/addressing resolution, location dependencies, etc.

The S-GW 1832 may terminate the SI interface 322 towards the RAN 1806, and routes data packets between the RAN 1806 and the CN 1828. In addition, the S-GW 1832 may be a local mobility anchor point for inter-RAN node handovers and also may provide an anchor for inter-3 GPP mobility. Other responsibilities may include lawful intercept, charging, and some policy enforcement.

The P-GW 1834 may terminate an SGi interface toward a PDN. The P-GW 1834 may route data packets between the CN 1828 (e.g., an EPC network) and external networks such as a network including the application server 1842 (alternatively referred to as application function (AF)) via an Internet Protocol (IP) interface (shown as IP communications interface 1838). Generally, an application server 1842 may be an element offering applications that use IP bearer resources with the core network (e.g., ETMTS Packet Services (PS) domain, LTE PS data services, etc.). In this embodiment, the P-GW 1834 is shown to be communicatively coupled to an application server 1842 via an IP communications interface 1838. The application server 1842 can also be configured to support one or more communication services (e.g., Voice-over-Internet Protocol (VoIP) sessions, PTT sessions, group communication sessions, social networking services, etc.) for the UE 1802 and the UE 1804 via the CN 1828.

The P-GW 1834 may further be a node for policy enforcement and charging data collection. A Policy and Charging Enforcement Function (PCRF) (shown as PCRF 1840) is the policy and charging control element of the CN 1828. In a non-roaming scenario, there may be a single PCRF in the Home Public Land Mobile Network (HPLMN) associated with a ETE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1840 may be communicatively coupled to the application server 1842 via the P-GW 1834. The application server 1842 may signal the PCRF 1840 to indicate a new service flow and select the appropriate Quality of Service (QOS) and charging parameters. The PCRF 1840 may provision this rule into a Policy and Charging Enforcement Function (PCEF) (not shown) with the appropriate traffic flow template (TFT) and QoS class of identifier (QCI), which commences the QoS and charging as specified by the application server 1842.

### Additional Examples

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.

Example 1 is a method performed by a user equipment (UE), comprising:

receiving, from a base station (BS), one or more messages comprising precoding information, wherein the precoding information is used by the UE to determine a precoder used in a codebook based Physical Uplink Shared Channel (PUSCH) transmission;

performing, by the UE, the codebook-based PUSCH transmission using eight antenna ports based on the precoder.

Example 2 is the method of example 1, wherein the precoder is determined from a first sub-precoder and a second sub-precoder, the first sub-precoder is determined from a first codebook and the second sub-precoder is determined from a second codebook.

Example 3 is the method of example 2,

wherein the eight antenna ports comprise two antenna panels,

wherein the first sub-precoder is associated with a first antenna panel and the second sub-precoder is associated with a second antenna panel,

wherein both the first codebook and the second codebook are four-transmitter codebook, and

wherein the precoder is a concatenation determined from the first sub-precoder, the second sub-precoder and a cophase between the first antenna panel and the second antenna panel.

Example 4 is the method of example 3, wherein the precoding information comprises a first Transmit Precoder Matrix Indicator (TPMI), a second TPMI, and a co-phasing indication indicating the cophase, wherein the first sub-precoder is selected from the first codebook based on the first TPMI and the second sub-precoder is selected from the second codebook based on the second TPMI.

Example 5 is the method of example 3, wherein the precoding information comprises a TPMI, wherein the precoder is selected from an eight-transmitter codebook based on the TPMI, wherein the eight-transmitter codebook comprises the concatenation determined from the first sub-precoder, the second sub-precoder and the cophase.

Example 6 is the method of example 5, wherein the eight-transmitter codebook further comprises at least one non-coherent precoder and at least one partial coherent precoder, wherein the at least one non-coherent precoder is used for non-coherent PUSCH transmission and the at least one partial coherent precoder is used for partially coherent PUSCH transmission.

Example 7 is the method of example 6, wherein each of the at least one non-coherent precoder is a matrix including one vector having a non-zero value in each column, wherein each of the at least partial coherent precoder is a matrix including one vector having two or more non-zero value in each column.

Example 8 is the method of example 3, wherein the precoding information comprises a TPMI and a co-phasing indication indicating the cophase, wherein the first sub-precoder is selected from the first codebook based on the TPMI and the second sub-precoder is the same as the first precoder.

Example 9 is the method of example 2, wherein the first codebook is a four-transmitter codebook and the second codebook is a two-transmitter codebook, wherein the precoder is determined based on a Kronecker product of the first sub-precoder and the second sub-precoder.

Example 10 is the method of example 9, wherein the precoding information comprises a first TPMI, a second TPMI, the first sub-precoder is determined from the first codebook based on the first TPMI the second sub-precoder is selected from the second codebook based on the second TPMI.

Example 11 is the method of example 10, wherein the precoding information further comprises a permutation indication indicating a permutation matrix, wherein the first sub-precoder is determined by applying the permutation matrix to a first sub-precoder candidate, the first sub-precoder candidate is selected from the first codebook based on the first TPMI.

Example 12 is the method of example 10, wherein the precoding information further comprises a permutation indication indicating a permutation matrix, wherein the precoder is determined by applying the permutation matrix to the Kronecker product of the first sub-precoder and the second sub-precoder.

Example 13 is the method of example 11, wherein the applying the permutation matrix to the first sub-precoder candidate comprises applying the permutation matrix to rows of the first sub-precoder candidate, applying the permutation matrix to columns of the first sub-precoder candidate, or applying the permutation matrix to the rows and the columns of the first sub-precoder candidate.

Example 14 is the method of example 9, where a phase representation of the two-transmitter codebook is determined from a 8 Phase Shift Keying (PSK) or a 16 PSK constellation.

Example 15 is the method of example 1, wherein the precoding information comprises a TPMI, wherein a precoder candidate is selected from an eight-transmitter codebook based on the TPMI, and wherein the precoder is determined by applying a permutation matrix to the precoder candidate.

Example 16 is the method of example 15, wherein the precoding information further comprises a permutation indication, wherein the permutation matrix is selected from a plurality of permutation matrices based on the permutation indication.

Example 17 is the method of example 15, wherein the permutation matrix is configured through a radio resource control (RRC), a media access control (MAC) control element (CE) or a

Example 18 is the method of example 15, wherein the applying the permutation matrix to the precoder candidate comprises applying the permutation matrix to rows of the precoder candidate, applying the permutation matrix to columns of the precoder candidate, or applying the permutation matrix to the rows and the columns of the precoder candidate.

Example 19 is the method of example 1, wherein the eight antenna ports are of a same polarization, wherein the precoder is determined from a two-stage codebook comprising a first precoding matrix and a second precoding matrix.

Example 20 is the method of example 19, wherein the eight antenna ports are facing a same direction, wherein the first precoding matrix is a beam group determined by Direct Fourier Transform (DFT) beams of the eight antenna ports.

Example 21 is the method of example 19, wherein the first precoding matrix is a block diagonal matrix, each element of the main diagonal of the block diagonal matrix is associated with a corresponding antenna panel of the plurality of antenna panels.

Example 22 is the method of example 1,

wherein the eight antenna ports comprise a plurality of antenna panels, each of the plurality of antenna panels is associated with a corresponding precoder,

wherein each pair of two antenna panels of the plurality of antenna panels is associated with a corresponding adjustment parameter for adjusting an amplitude and a phase between the pair of two antenna panels, and a corresponding compensation of a propagation delay between the pair of two antenna panels,

wherein the precoder is determined based on all corresponding precoders, all corresponding adjustment parameters and all corresponding compensations.

Example 23 is the method of example 22, wherein the precoding information comprise a corresponding TPMI, the corresponding adjustment parameter and the corresponding compensation, wherein the corresponding TPMI indicates the corresponding precoder, and wherein the precoding information is separately configured in a RRC, a MAC CE, or a DCI.

Example 24 is the method of example 1, wherein the precoding information comprises a sounding reference signal resource indicator (SRI), wherein the SRI indicates one or more SRS resources for the codebook-based PUSCH transmission.

Example 25 is the method of example 24, wherein the one or more SRS resources comprise a single SRS resource for the codebook-based PUSCH transmission with the eight antenna ports.

Example 26 is the method of example 24,

wherein the one or more SRS resources comprise two or more SRS resources, wherein the eight antenna ports comprise two or more antenna panels corresponding to the two or more SRS resources,

wherein the SRI comprises additional bits for selecting panels from the two or more antenna panels used in the codebook-based PUSCH.

Example 27 is the method of example 26, wherein the additional bits comprise a combinatorial index or a bitmap.

Example 28 is the method of example 26, wherein the SRI is indicated in a MAC-CE.

Example 29 is the method of example 1, wherein the precoder is a two-stage codebook comprising a first precoding matrix and a second precoding matrix, wherein the precoding information indicates the first precoding matrix and the second precoding matrix.

Example 30 is the method of example 29, wherein both the first precoding matrix and the second precoding matrix are indicated in a dynamical signaling, wherein the dynamical signaling comprises one additional bit indicating whether the dynamical signaling is used to update the first precoding matrix or the second precoding matrix.

Example 31 is the method of example 29, wherein both the first precoding matrix and the second precoding matrix are indicated in a dynamical signaling,

wherein the dynamical signaling comprises a number of bits creating a plurality of code states,

wherein a first number of the code states indicate the first precoding matrix and a second number of the code states indicate the second precoding matrix, and

wherein a sum of the first number and the second number is less than or equal to a number of the code states.

Example 32 is the method of example 29, wherein both the first precoding matrix and the second precoding matrix are indicated in a dynamical signaling,

wherein the first precoding matrix is selected from a group of first precoding matrix candidates, and the second precoding matrix is selected from a first group of second precoding matrix candidates or a second group of second precoding matrix candidates,

wherein the dynamical signaling comprises a number of bits creating a plurality of code states,

wherein a first number of the code states indicate the first precoding matrix and the second precoding matrix selected from the first group of second precoding matrix candidates,

wherein a second number of the code states indicate the second precoding matrix selected from the second group of second precoding matrix candidates,

wherein the number of bits is determined by the first number and the second number.

Example 33 is the method of example 32, wherein in response to a pair of the first precoding matrix and the second precoding matrix selected from the first group of second precoding matrix candidates is not supported, a code state represented by the pair is reduced from the first number of the code states.

Example 34 is the method of any one of examples 30-33, wherein the first precoding matrix is indicated less frequently than the second precoding matrix.

Example 35 is the method of example 29, wherein first precoding matrix is indicated in a MAC CE and the second precoding matrix is indicated in a dynamical signaling.

Example 36 is the method of example 29, wherein first precoding matrix is indicated in a MAC CE or a dynamical signaling to support open-loop uplink transmission, wherein the second precoding matrix is selected from a group of second precoding matrix candidates during each repetition of the codebook-based PUSCH transmission.

Example 37 is the method of example 1, wherein the codebook-based PUSCH is a configured grant (CG) PUSCH, wherein the precoding information is indicated through MAC CE or DCI to update the precoder.

Example 38 is the method of example 1, wherein the precoder is used for wideband precoding or subband precoding.

Example 39 is a method performed by a base station (BS), comprising:

transmitting, to a user equipment (UE), one or more messages comprising precoding information, wherein the precoding information is used by the UE to determine a precoder used in a codebook based Physical Uplink Shared Channel (PUSCH) transmission;

receiving, from the UE, the codebook-based PUSCH transmission using eight antenna ports based on the precoder.

Example 40 is the method of example 39, wherein the precoder is determined from a first sub-precoder and a second sub-precoder, the first sub-precoder is determined from a first codebook and the second sub-precoder is determined from a second codebook.

Example 41 is the method of example 40,

wherein the eight antenna ports comprise two antenna panels,

wherein the first sub-precoder is associated with a first antenna panel and the second sub-precoder is associated with a second antenna panel,

wherein both the first codebook and the second codebook are four-transmitter codebook, and

wherein the precoder is a concatenation determined from the first sub-precoder, the second sub-precoder and a cophase between the first antenna panel and the second antenna panel.

Example 42 is the method of example 41, wherein the precoding information comprises a first Transmit Precoder Matrix Indicator (TPMI), a second TPMI, and a co-phasing indication indicating the cophase, wherein the first sub-precoder is selected from the first codebook based on the first TPMI and the second sub-precoder is selected from the second codebook based on the second TPMI.

Example 43 is the method of example 41, wherein the precoding information comprises a TPMI, wherein the precoder is selected from an eight-transmitter codebook based on the TPMI, wherein the eight-transmitter codebook comprises the concatenation determined from the first sub-precoder, the second sub-precoder and the cophase.

Example 44 is the method of example 43, wherein the eight-transmitter codebook further comprises at least one non-coherent precoder and at least one partial coherent precoder, wherein the at least one non-coherent precoder is used for non-coherent PUSCH transmission and the at least one partial coherent precoder is used for partially coherent PUSCH transmission.

Example 45 is the method of example 44, wherein each of the at least one non-coherent precoder is a matrix including one vector having a non-zero value in each column, wherein each of the at least partial coherent precoder is a matrix including one vector having two or more non-zero value in each column.

Example 46 is the method of example 41, wherein the precoding information comprises a TPMI and a co-phasing indication indicating the cophase, wherein the first sub-precoder is selected from the first codebook based on the TPMI and the second sub-precoder is the same as the first precoder.

Example 47 is the method of example 40, wherein the first codebook is a four-transmitter codebook and the second codebook is a two-transmitter codebook, wherein the precoder is determined based on a Kronecker product of the first sub-precoder and the second sub-precoder.

Example 48 is the method of example 47, wherein the precoding information comprises a first TPMI, a second TPMI, the first sub-precoder is determined from the first codebook based on the first TPMI the second sub-precoder is selected from the second codebook based on the second TPMI.

Example 49 is the method of example 48, wherein the precoding information further comprises a permutation indication indicating a permutation matrix, wherein the first sub-precoder is determined by applying the permutation matrix to a first sub-precoder candidate, the first sub-precoder candidate is selected from the first codebook based on the first TPMI.

Example 50 is the method of example 48, wherein the precoding information further comprises a permutation indication indicating a permutation matrix, wherein the precoder is determined by applying the permutation matrix to the Kronecker product of the first sub-precoder and the second sub-precoder.

Example 51 is the method of example 49, wherein the applying the permutation matrix to the first sub-precoder candidate comprises applying the permutation matrix to rows of the first sub-precoder candidate, applying the permutation matrix to columns of the first sub-precoder candidate, or applying the permutation matrix to the rows and the columns of the first sub-precoder candidate.

Example 52 is the method of example 47, where a phase representation of the two-transmitter codebook is determined from a 8 Phase Shift Keying (PSK) or a 16 PSK constellation.

Example 53 is the method of example 39, wherein the precoding information comprises a TPMI, wherein a precoder candidate is selected from an eight-transmitter codebook based on the TPMI, and wherein the precoder is determined by applying a permutation matrix to the precoder candidate.

Example 54 is the method of example 53, wherein the precoding information further comprises a permutation indication, wherein the permutation matrix is selected from a plurality of permutation matrices based on the permutation indication.

Example 55 is the method of example 53, wherein the permutation matrix is configured through a radio resource control (RRC), a media access control (MAC) control element (CE) or a

Example 56 is the method of example 53, wherein the applying the permutation matrix to the precoder candidate comprises applying the permutation matrix to rows of the precoder candidate, applying the permutation matrix to columns of the precoder candidate, or applying the permutation matrix to the rows and the columns of the precoder candidate.

Example 57 is the method of example 39, wherein the eight antenna ports are of a same polarization, wherein the precoder is determined from a two-stage codebook comprising a first precoding matrix and a second precoding matrix.

Example 58 is the method of example 57, wherein the eight antenna ports are facing a same direction, wherein the first precoding matrix is a beam group determined by Direct Fourier Transform (DFT) beams of the eight antenna ports.

Example 59 is the method of example 57, wherein the first precoding matrix is a block diagonal matrix, each element of the main diagonal of the block diagonal matrix is associated with a corresponding antenna panel of the plurality of antenna panels.

Example 60 is the method of example 39,

wherein the eight antenna ports comprise a plurality of antenna panels, each of the plurality of antenna panels is associated with a corresponding precoder,

wherein each pair of two antenna panels of the plurality of antenna panels is associated with a corresponding adjustment parameter for adjusting an amplitude and a phase between the pair of two antenna panels, and a corresponding compensation of a propagation delay between the pair of two antenna panels,

wherein the precoder is determined based on all corresponding precoders, all corresponding adjustment parameters and all corresponding compensations.

Example 61 is the method of example 60, wherein the precoding information comprise a corresponding TPMI, the corresponding adjustment parameter and the corresponding compensation, wherein the corresponding TPMI indicates the corresponding precoder, and wherein the precoding information is separately configured in a RRC, a MAC CE, or a DCI.

Example 62 is the method of example 39, wherein the precoding information comprises a sounding reference signal resource indicator (SRI), wherein the SRI indicates one or more SRS resources for the codebook-based PUSCH transmission.

Example 63 is the method of example 62, wherein the one or more SRS resources comprise a single SRS resource for the codebook-based PUSCH transmission with the eight antenna ports.

Example 64 is the method of example 62,

wherein the one or more SRS resources comprise two or more SRS resources, wherein the eight antenna ports comprise two or more antenna panels corresponding to the two or more SRS resources,

wherein the SRI comprises additional bits for selecting panels from the two or more antenna panels used in the codebook-based PUSCH.

Example 65 is the method of example 64, wherein the additional bits comprise a combinatorial index or a bitmap.

Example 66 is the method of example 64, wherein the SRI is indicated in a MAC-CE.

Example 67 is the method of example 39, wherein the precoder is a two-stage codebook comprising a first precoding matrix and a second precoding matrix, wherein the precoding information indicates the first precoding matrix and the second precoding matrix.

Example 68 is the method of example 67, wherein both the first precoding matrix and the second precoding matrix are indicated in a dynamical signaling, wherein the dynamical signaling comprises one additional bit indicating whether the dynamical signaling is used to update the first precoding matrix or the second precoding matrix.

Example 69 is the method of example 67, wherein both the first precoding matrix and the second precoding matrix are indicated in a dynamical signaling,

wherein the dynamical signaling comprises a number of bits creating a plurality of code states,

wherein a first number of the code states indicate the first precoding matrix and a second number of the code states indicate the second precoding matrix, and

wherein a sum of the first number and the second number is less than or equal to a number of the code states.

Example 70 is the method of example 67, wherein both the first precoding matrix and the second precoding matrix are indicated in a dynamical signaling,

wherein the first precoding matrix is selected from a group of first precoding matrix candidates, and the second precoding matrix is selected from a first group of second precoding matrix candidates or a second group of second precoding matrix candidates,

wherein the dynamical signaling comprises a number of bits creating a plurality of code states,

wherein a first number of the code states indicate the first precoding matrix and the second precoding matrix selected from the first group of second precoding matrix candidates,

wherein a second number of the code states indicate the second precoding matrix selected from the second group of second precoding matrix candidates,

wherein the number of bits is determined by the first number and the second number.

Example 71 is the method of example 70, wherein in response to a pair of the first precoding matrix and the second precoding matrix selected from the first group of second precoding matrix candidates is not supported, a code state represented by the pair is reduced from the first number of the code states.

Example 72 is the method of any one of examples 68-70, wherein the first precoding matrix is indicated less frequently than the second precoding matrix.

Example 73 is the method of example 67, wherein first precoding matrix is indicated in a MAC CE and the second precoding matrix is indicated in a dynamical signaling.

Example 74 is the method of example 67, wherein first precoding matrix is indicated in a MAC CE or a dynamical signaling to support open-loop uplink transmission, wherein the second precoding matrix is selected from a group of second precoding matrix candidates during each repetition of the codebook-based PUSCH transmission.

Example 75 is the method of example 39, wherein the codebook-based PUSCH is a configured grant (CG) PUSCH, wherein the precoding information is indicated through MAC CE or DCI to update the precoder.

Example 76 is the method of example 39, wherein the precoder is used for wideband precoding or subband precoding.

Example 77 is an apparatus for a user equipment (UE), the apparatus comprising:

one or more processors configured to perform steps of the method according to any of examples 1-38.

Example 78 is an apparatus for a base station (BS), the apparatus comprising:

one or more processors configured to perform steps of the method according to any of examples 39-76.

Example 79 is a computer readable medium having computer programs stored thereon which, when executed by one or more processors, cause an apparatus to perform steps of the method according to any of examples 1-76.

Example 80 is an apparatus for a communication device, comprising means for performing steps of the method according to any of examples 1-76.

Example 81 is a computer program product comprising computer programs which, when executed by one or more processors, cause an apparatus to perform steps of the method according to any of examples 1-76.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1-81. (canceled)

82. A method comprising:
receiving, from a base station (BS), one or more messages that include precoding information;
determining, based on the precoding information, a precoder; and
generating, based on the precoder, a codebook-based physical uplink shared channel (PUSCH) transmission using eight antenna ports.

83. The method of claim 82, wherein determining the precoder comprises:
determining the precoder from a first sub-precoder and a second sub-precoder, wherein the first sub-precoder is determined from a first codebook and the second sub-precoder is determined from a second codebook.

84. The method of claim 83, wherein:
the eight antenna ports correspond to two antenna panels;
the first sub-precoder is associated with a first antenna panel and the second sub-precoder is associated with a second antenna panel;
both the first codebook and the second codebook are four-transmitter codebooks; and
the precoder is a concatenation determined from the first sub-precoder, the second sub-precoder, and a cophase between the first antenna panel and the second antenna panel.

85. The method of claim 84, wherein the precoding information comprises a first transmit precoder matrix indicator (TPMI), a second TPMI, and a co-phasing indication indicating the cophase, wherein the first sub-precoder is selected from the first codebook based on the first TPMI and the second sub-precoder is selected from the second codebook based on the second TPMI.

86. The method of claim 83, wherein the first codebook is a four-transmitter codebook and the second codebook is a two-transmitter codebook, wherein the precoder is determined based on a Kronecker product of the first sub-precoder and the second sub-precoder.

87. The method of claim 86, wherein the precoding information comprises a first TPMI, a second TPMI, the first sub-precoder is determined from the first codebook based on the first TPMI the second sub-precoder is selected from the second codebook based on the second TPMI.

88. The method of claim 82, wherein the precoding information comprises a transmit precoder matrix indicator (TPMI), wherein a precoder candidate is selected from an eight-transmitter codebook based on the TPMI, and wherein the precoder is determined by applying a permutation matrix to the precoder candidate.

89. The method of claim 88, wherein the precoding information further comprises a permutation indication, wherein the permutation matrix is selected from a plurality of permutation matrices based on the permutation indication.

90. The method of claim 82, wherein:
the eight antenna ports comprise a plurality of antenna panels, each of the plurality of antenna panels is associated with a corresponding precoder;
each pair of two antenna panels of the plurality of antenna panels is associated with a corresponding adjustment parameter for adjusting an amplitude and a phase between the pair of two antenna panels, and a corresponding compensation of a propagation delay between the pair of two antenna panels; and
the precoder is determined based on all corresponding precoders, all corresponding adjustment parameters and all corresponding compensations.

91. The method of claim 82, wherein the precoding information comprises a sounding reference signal resource indicator (SRI), wherein the SRI indicates one or more SRS resources for the codebook-based PUSCH transmission.

92. One or more non-transitory, computer-readable media having instructions that, when executed, cause processing circuitry to:
receive, from a base station (BS), one or more messages that include precoding information;
determine, based on the precoding information, a precoder; and
generate, based on the precoder, a codebook-based physical uplink shared channel (PUSCH) transmission using eight antenna ports.

93. The one or more non-transitory, computer-readable media of claim 92, wherein to determine the precoder the processing circuitry is to:
determine the precoder from a first sub-precoder and a second sub-precoder, wherein the first sub-precoder is determined from a first codebook and the second sub-precoder is determined from a second codebook.

94. An apparatus comprising:
one or more processors to:
generate, for transmission to a user equipment (UE), one or more messages that include precoding information, wherein the precoding information is to identify a precoder to be used for a codebook-based physical uplink shared channel (PUSCH) transmission using eight antenna ports; and
receive, from the UE, the codebook-based PUSCH transmission; and
an interface coupled to the one or more processors to enable communication.

95. The apparatus of claim 94, wherein the precoder is to be determined from a first sub-precoder and a second sub-precoder, the first sub-precoder is to be determined from a first codebook and the second sub-precoder is to be determined from a second codebook.

96. The apparatus of claim 95, wherein:
the eight antenna ports correspond to two antenna panels;
the first sub-precoder is associated with a first antenna panel and the second sub-precoder is associated with a second antenna panel;
both the first codebook and the second codebook are four-transmitter codebooks; and
the precoder is a concatenation to be determined from the first sub-precoder, the second sub-precoder, and a cophase between the first antenna panel and the second antenna panel.

97. The apparatus of claim 96, wherein the precoding information comprises a first transmit precoder matrix indicator (TPMI), a second TPMI, and a co-phasing indication indicating the cophase, wherein the first sub-precoder is to be selected from the first codebook based on the first TPMI and the second sub-precoder is to be selected from the second codebook based on the second TPMI.

98. The apparatus of claim 95, wherein: the first codebook is a four-transmitter codebook and the second codebook is a two-transmitter codebook; and the precoder is to be determined based on a Kronecker product of the first sub-precoder and the second sub-precoder.

99. The apparatus of claim 98, wherein: the precoding information comprises a first TPMI and a second TPMI; the first sub-precoder is to be selected from the first codebook based on the first TPMI; and the second sub-precoder is to be selected from the second codebook based on the second TPMI.

100. The apparatus of claim 94, wherein:
the precoding information comprises a TPMI and a permutation indication;
a precoder candidate is selected from an eight-transmitter codebook based on the TPMI;
a permutation matrix is to be selected from a plurality of permutation matrices based on the permutation indication; and
the precoder is to be determined by applying the permutation matrix to the precoder candidate.

101. The apparatus of claim 94, wherein:
the eight antenna ports comprise a plurality of antenna panels and each of the plurality of antenna panels is associated with a corresponding precoder;
each pair of two antenna panels of the plurality of antenna panels is associated with a corresponding adjustment parameter for adjusting an amplitude and a phase between the pair of two antenna panels, and a corresponding compensation of a propagation delay between the pair of two antenna panels; and
the precoder is to be determined based on all corresponding precoders, all corresponding adjustment parameters, and all corresponding compensations.
